(19) United States
(12) Patent Application Publication
(10) Pub. No.: US 2008/0140287 A1
(43) Pub. Date: Jun. 12, 2008

(54) SYSTEM AND METHOD FOR INFORMING VEHICLE ACCIDENT USING TELEMATICS DEVICE

(76) Inventors: Man Seok YANG, Daejeon (KR); Heung Nam KIM, Daejeon (KR); Dong Sun LIM, Daejeon (KR); Tae Man HAN, Daejeon (KR); Mi Ryong PARK, Daejeon (KR); Tae Joon PARK, Seoul (KR)

Correspondence Address: LADAS & PARRY LLP, 224 SOUTH MICHIGAN AVENUE, SUITE 1600, CHICAGO, IL, 60604, US

(21) Appl. No.: 11/950,541

(22) Filed: Dec. 5, 2007

(30) Foreign Application Priority Data
Dec. 6, 2006 (KR) 10-2006-0122892
Aug. 10, 2007 (KR) 10-2007-0080806

(51) Int. Cl. G08G 1/0965; G08G 1/0968

(52) U.S. Cl. 701/45; 701/117; 701/201

(57) ABSTRACT

Provided are a system and method for informing a vehicle accident using a telematics device. In an emergency, such as vehicle collision, etc., the system and method propagate information on the accident to vehicles around the accident scene, thereby informing the vehicles of traffic congestion. Since the vehicles continuously inform the same to vehicles behind through ad-hoc communication, a vehicle guided by a telematics device can recognize the traffic congestion ahead, re-search for a path, and thereby make a detour. Therefore, although vehicles behind the accident scene cannot see the occurrence of the accident on a foggy highway, etc., the risk of a chain-reaction crash is reduced. In addition, it is possible to avoid traffic congestion due to an accident in downtown.

### CROSS-REFERENCE TO RELATED APPLICATION

This application claims priority to and the benefit of Korean Patent Application No. 2006-122892, filed Dec. 6, 2006, and No. 2007-80806, filed Aug. 10, 2007, the disclosure of which is incorporated herein by reference in its entirety.

### BACKGROUND

1. Field of the Invention

The present invention relates to a system and method for informing a vehicle accident using a telematics device, and more particularly, to a system and method whereby a telematics device installed in a vehicle detects the occurrence of a traffic accident and transmits information on the accident to vehicles around the accident-involved vehicle, telematics devices installed in the neighboring vehicles receive the information and warn their drivers according to the received information, and thereby the vehicles can immediately cope with the traffic accident.

The present invention has been produced from the work supported by the IT R&D program of MIC (Ministry of Information and Communication)/IITA (Institute for Information Technology Advancement) [2005-S-042-02, Telematics Clients SW Platform and Information Management Technology] in Korea.

2. Discussion of Related Art

Conventional telematics devices equipped with a navigation system have been mainly aimed at providing a path from an origin to a destination to drivers. Lately, telematics devices receive information on traffic flows in connection with a traffic information center and provide a new path so that drivers can avoid a congested path. However, such information on traffic flows, e.g., information indicating that a traffic accident has occurred at a place and traffic is congested, is provided to drivers via the traffic information center, and thus the drivers can receive the information after some time elapses from the occurrence of the traffic accident. Therefore, when a traffic accident occurs in a road like a highway in which vehicles run at high speed and a traffic volume is high, vehicles around the accident scene cannot immediately cope with the accident.

### SUMMARY OF THE INVENTION

The present invention is directed to providing a system and method for, when a vehicle accident occurs, transmitting real-time information on the accident to vehicles around an accident-involved vehicle and thereby letting the neighboring vehicles immediately cope with the accident.

One aspect of the present invention provides a method of informing a vehicle accident using a telematics device, the method comprising the steps of: establishing, by a telematics device installed in a vehicle, an inter-vehicle network between the vehicle and other vehicles around the vehicle through ad-hoc communication; detecting, by a vehicle sensor installed in the vehicle, an impact and transmitting impact data to the telematics device; determining, by the telematics device, seriousness of an accident based on the transmitted impact data; controlling the vehicle according to the determined seriousness of the accident; and transmitting an accident informing message to telematics devices of the neighboring vehicles connected to the inter-vehicle network.

Another aspect of the present invention provides a system for informing a vehicle accident using a telematics device, comprising: a vehicle sensor for detecting an impact to a vehicle and transmitting impact data; a vehicle control device for controlling operation of the vehicle; and the telematics device wiredly or wirelessly connected with the vehicle sensor and the vehicle control device for determining whether an accident of the vehicle has occurred or not and transmitting an accident informing message to vehicles around the vehicle. Here, the telematics device comprises: an input unit for receiving the impact data transmitted from the vehicle sensor; a vehicle control unit for transmitting a vehicle control signal to the vehicle control device; a communication module for establishing an inter-vehicle network through ad-hoc communication with telematics devices installed in the neighboring vehicles; a control unit for analyzing the impact data received from the input unit to see whether an accident has occurred or not and issuing a control instruction to the vehicle control unit; and an output unit for transmitting information relating to the accident according to the instruction from the control unit.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of a system for informing a vehicle accident using telematics device according to an exemplary embodiment of the present invention;

FIG. 2 is a flowchart showing a process of a vehicle involved in an accident according to an exemplary embodiment of the present invention; and

FIG. 3 is a flowchart showing a process of a vehicle around an accident-involved vehicle according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

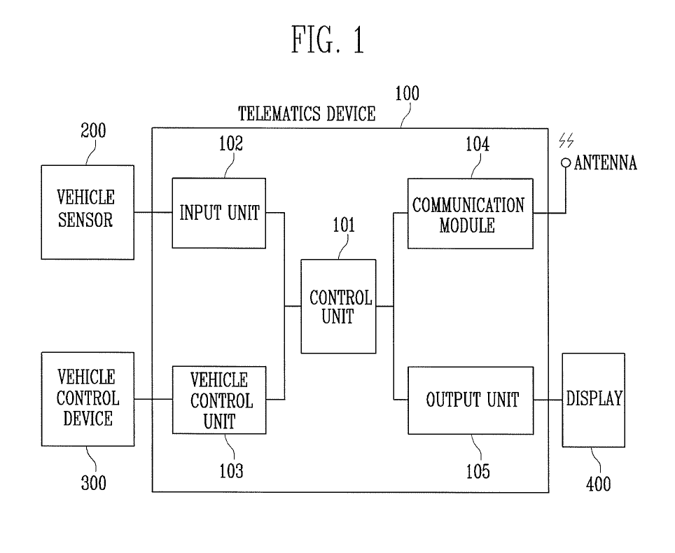

FIG. 1 is a block diagram of a system for informing a vehicle accident using telematics device according to an exemplary embodiment of the present invention.

Referring to FIG. 1, the system according to an exemplary embodiment of the present invention comprises a telemetics device 100, a vehicle sensor 200, a vehicle control device 300 and a display 400.

The vehicle sensor 200 is installed in a vehicle and transmits detected data on an impact from the vehicle to the telematics device 100 wiredly or wirelessly. The telematics device 100 receives the impact data from the vehicle sensor 200 and can determine whether an accident has occurred or not, based on the impact data.

The vehicle control device 300 includes various control devices, such as a brake, an airbag, etc., that control operation of the vehicle, and controls the vehicle according to a control signal from the telematics device 100.

The display 400 visually and/or audibly provides the driver of the vehicle with information relating to an accident, such as an accident occurrence message or a slow-down recommendation message provided by the telematics device 100.

The telematics device 100 is wirelessly or wiredly connected with the vehicle sensor 200, the vehicle control device 300, and the display 400, and includes a control unit 101, an input unit 102, a vehicle control unit 103, a communication module 104 and an output unit 105. The control unit 101 analyzes the impact data received at the input unit 102 to see whether an accident has occurred or not and issues a control instruction to the vehicle control unit 103, and analyzes various pieces of information received via the communication module 104 to issue an instruction to the vehicle control unit 103 or the output unit 105 according to the analysis result, thereby controlling the overall operation of the telematics device 100. The input unit 102 is connected with the vehicle sensor 200 installed in the vehicle, receives the impact data transmitted from the vehicle sensor 200, and transmits again the impact data to the control unit 101. The vehicle control unit 103 is connected with the vehicle control device 300 installed in the vehicle and transmits a vehicle control signal to the vehicle control device 300 according to the instruction from the control unit 101. The communication module 104 establishes an inter-vehicle network through ad-hoc communication with telematrics devices installed in neighboring vehicles. Since an ad-hoc network consists of only mobile hosts without a fixed wired network, it is appropriate for a case in which it is difficult to establish a wired network, or an established network will be used for a short time period. In the ad-hoc network, a host can move without restraint, and neither a wired network nor a base station is needed. Thus, the ad-hoc network has advantages of fast network establishment and low cost. The output unit 105 is connected with the external display 400 and transmits various pieces of information relating to an accident to the display according to the instruction from the control unit 101.

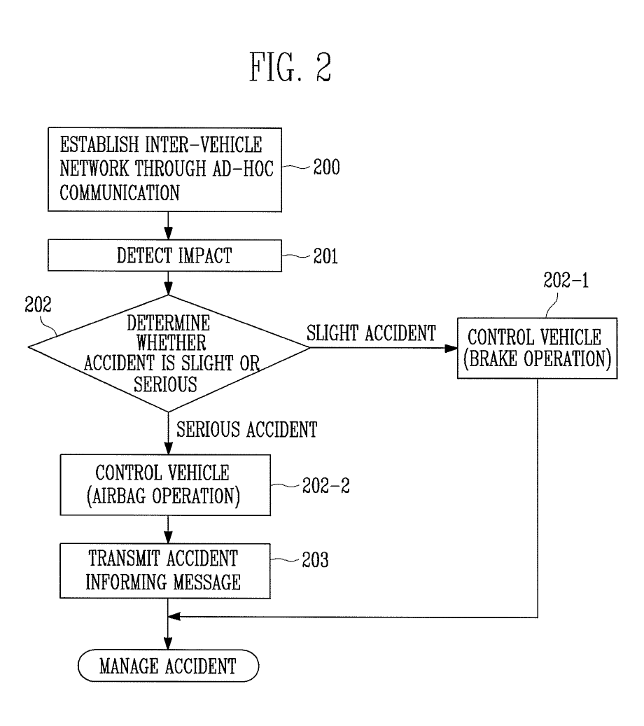

FIG. 2 is a flowchart showing a process of a vehicle involved in an accident according to an exemplary embodiment of the present invention.

While a vehicle equipped with a telematics device of the present invention travels along a road, the telematics device establishes an inter-vehicle network through ad-hoc communication with other telematics devices installed in neighboring vehicles via a communication module (200). When a vehicle sensor installed in the vehicle detects an impact, it transmits impact data to the telematics device (201). The telematics device analyzes the transmitted impact data and determines the seriousness of an accident according to the impact data (202). For example, when an amount of the impact transmitted from the vehicle sensor is less than a predetermined value, the accident may be determined as a slight accident, and when the amount of the impact is the predetermined value or more, the accident may be determined as a serious accident. When the accident is determined as a slight accident, the telematics device issues a corresponding control instruction to a vehicle control device (202-1). For example, the telematics device may instruct the vehicle control device to perform an operation for reducing vehicle speed, e.g., a brake operation. On the other hand, when the accident is determined as a serious accident, the telematics device issues a corresponding control instruction to the vehicle control device (202-2). For example, the telematics device may instruct the vehicle control device to perform an operation for immediately protecting the driver of the vehicle, e.g., an airbag operation. Subsequently, the telematics device transmits an accident informing message to the telematics devices of the neighboring vehicles connected with the inter-vehicle network through the communication module (203). The accident informing message may include information on the location of the accident, the seriousness of the accident, the registration number of the accident-involved vehicle, and so on.

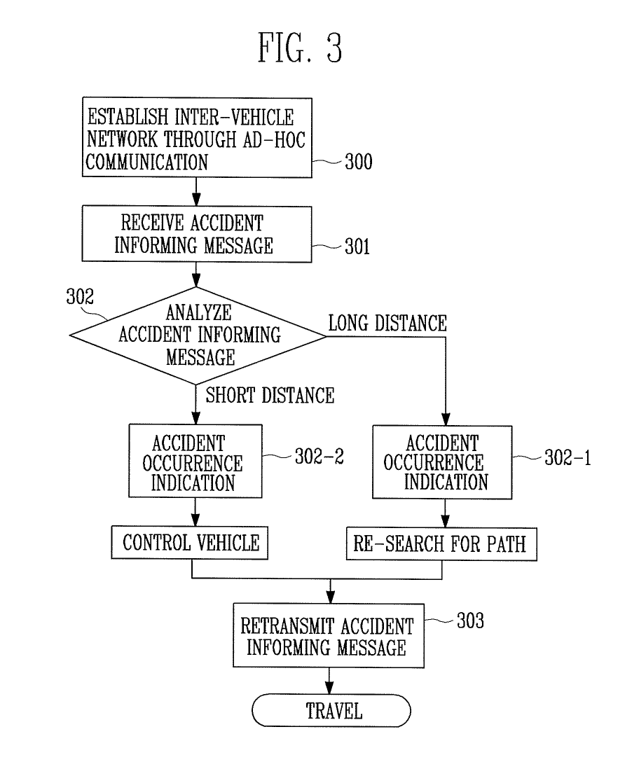

FIG. 3 is a flowchart showing a process of a vehicle around an accident-involved vehicle according to an exemplary embodiment of the present invention.

While a vehicle equipped with a telematics device of the present invention travels along a road, the telematics device establishes an inter-vehicle network through ad-hoc communication with other telematics devices installed in neighboring vehicles via a communication module (300).

The telematics device of the vehicle receives an accident informing message from the telematics device of a neighboring vehicle connected with the inter-vehicle network (301). The telematics device analyzes the received accident informing message (302). For example, the telematics device analyzes the location of an accident included in the accident informing message to determine a distance from an accident-involved vehicle. When the accident-involved vehicle is at a short distance (302-2), the telematics device may visually and/or audibly provide an accident occurrence indication to the driver of the vehicle through a display and transmit a control signal to the vehicle control device to stop the vehicle or reduce the speed. When the accident-involved vehicle is at a long distance (302-1), the telematics device visually and/or audibly provides an accident occurrence indication to the driver through the display, like the case of a short distance, but does not instruct the vehicle control device to immediately control the vehicle. Rather, the telematics device determines whether the vehicle is to detour or to go slow according to the seriousness of the accident, and re-searches for a path when the vehicle is to detour.

The telematics device receiving the accident informing message may retransmit the message to the telematics device of another neighboring vehicle (303). In this case, the retransmitted accident informing message may indicate that it is retransmitted via the currently transmitting vehicle, and thereby it is possible to prevent the accident informing message of the accident-involved vehicle from being transmitted farther than needed. It is analyzed how far the message has been propagated according to a road factor and the seriousness of the accident, so that usefulness of the message information can be determined.

As described above, the system and method according to an exemplary embodiment of the present invention let vehicles around an accident-involved vehicle immediately cope with an accident on a road, thereby preventing continuous accidents and allowing the vehicles to rapidly avoid traffic congestion due to the accident.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of informing a vehicle accident using a telematics device, the method comprising the steps of:
(a) establishing, by a telematics device installed in a vehicle, an inter-vehicle network between the vehicle and other vehicles around the vehicle through ad-hoc communication;
(b) detecting, by a vehicle sensor installed in the vehicle, an impact and transmitting impact data to the telematics device;
(c) determining, by the telematics device, seriousness of an accident based on the transmitted impact data;
(d) controlling the vehicle according to the determined seriousness of the accident; and
(e) transmitting an accident informing message to telematics devices of the neighboring vehicles connected to the inter-vehicle network.

2. The method of claim 1, wherein step (c) comprises the step of determining that the accident is slight when an amount of the impact detected by the vehicle sensor is less than a predetermined value, and determining that the accident is serious when the amount of the impact detected by the vehicle sensor is the predetermined value or more.

3. The method of claim 2, wherein step (d) comprises the step of operating a brake of the vehicle when the accident is determined to be slight, and operating an airbag of the vehicle when the accident is determined to be serious.

4. The method of claim 1, wherein the accident informing message includes information on an accident location of the vehicle, the seriousness of the accident and a registration number of the vehicle.

5. The method of claim 1, further comprising the steps of:
(f) receiving, by the telematics devices of the neighboring vehicles, the accident informing message;
(g) analyzing, by the telematics devices of the neighboring vehicles, the accident informing message; and
(h) retransmitting, by the telematics devices of the neighboring vehicles, the accident informing message.

6. The method of claim 5, wherein step (g) comprises the step of analyzing an accident location included in the accident informing message and determining a distance from the accident-involved vehicle.

7. The method of claim 6, wherein step (g) further comprises the step of, when it is determined that the distance from the accident-involved vehicle is short, visually and/or audibly providing an accident occurrence indication to drivers of the neighboring vehicles through a display and transmitting a control signal instructing to stop the vehicles or reduce speed, to vehicle control devices of the neighboring vehicles.

8. The method of claim 6, wherein step (g) further comprises the step of, when it is determined that the distance from the accident-involved vehicle is long, visually and/or audibly providing an accident occurrence indication to drivers of the neighboring vehicles through a display, determining whether the vehicle is to detour or to go slow according to the seriousness of the accident, and re-searching for a path when the vehicle is to detour.

9. The method of claim 5, wherein step (h) comprises the step of including, in the accident informing message, an indication that the accident informing message is retransmitted via the neighboring vehicles.

10. A system for informing a vehicle accident using a telematics device, the system comprising:
a vehicle sensor for detecting an impact to a vehicle and transmitting impact data;
a vehicle control device for controlling operation of the vehicle; and
the telematics device wiredly or wirelessly connected with the vehicle sensor and the vehicle control device for determining whether an accident of the vehicle has occurred or not and transmitting an accident informing message to vehicles around the vehicle,
wherein the telematics device comprises:
an input unit for receiving the impact data transmitted from the vehicle sensor;
a vehicle control unit for transmitting a vehicle control signal to the vehicle control device;
a communication module for establishing an inter-vehicle network through ad-hoc communication with telematics devices installed in the neighboring vehicles;
a control unit for analyzing the impact data received from the input unit to see whether an accident has occurred or not and issuing a control instruction to the vehicle control unit; and
an output unit for transmitting information relating to the accident according to the instruction from the control unit.

11. The system of claim 1O, further comprising a display for visually and/or audibly providing the information relating to the accident transmitted by the output unit to a driver of the vehicle.

12. The system of claim 10, wherein the accident informing message includes information on an accident location of the vehicle, seriousness of the accident and a registration number of the vehicle.

13. The system of claim 10, wherein the telematics device receives an accident informing message from a telematics device of a neighboring vehicle connected with the inter-vehicle network through the communication module.

14. The system of claim 13, wherein the telematics device receives the accident informing message from the telematics device of the neighboring vehicle, analyzes the received accident informing message, and retransmits the received accident informing message to a telematics device of still another neighboring vehicle connected with the inter-vehicle network.

15. The system of claim 14, wherein the retransmitted accident informing message includes information indicating that the accident informing message is retransmitted via the vehicle.
